(19) United States
(12) Patent Application Publication
(10) Pub. No.: US 2007/0113075 A1
(43) Pub. Date: May 17, 2007

(54) SECURE ROUTE OPTIMIZATION FOR MOBILE NETWORK USING MULTI-KEY CRYTOGRAPHICALLY GENERATED ADDRESSES

(75) Inventors: Manhee Jo, Sunnyvale, CA (US); James Kempf, Mountain View, CA (US)

Correspondence Address: MACPHERSON KWOK CHEN & HEID LLP, 2033 GATEWAY PLACE, SUITE 400, SAN JOSE, CA, 95110, US

(73) Assignee: NTT DoCoMo, Inc.

(21) Appl. No.: 11/557,283

(22) Filed: Nov. 7, 2006

Related U.S. Application Data
(60) Provisional application No. 60/735,749, filed on Nov. 10, 2005.

(51) Int. Cl. H04L 9/00

(52) U.S. Cl. 713/158; 370/401

(57) ABSTRACT

A method allows a mobile router that uses the Mobile Internet Protocol version 6 (Mobile IPv6) for mobility management to optimize routing by securely sending binding update messages directly to correspondent nodes on behalf of each mobile network node, even if the node does not perform Mobile IPv6 functions. Since the network address for each mobile network node is generated from the public keys of both the mobile network node and the mobile router, the mobile router is authorized to use the generated address on behalf of the mobile network node. If the mobile router changes its point of attachment, it sends signed binding update messages to the correspondent nodes of the mobile network nodes. When the correspondent nodes verify the binding update message and the correct public keys, the correspondent nodes can communicate with the mobile network node without going through the home agent. Therefore, secure proxy binding update messages can be sent from the mobile router.

### CROSS-REFERENCE TO RELATED APPLICATIONS

The present invention is related to and claims priority to U.S. provisional patent application (the “'749 Provisional Application”), entitled “Secure Route Optimization for Mobile Network Using Multi-key Cryptographically Generated Addresses,” Ser. No. 60/735,749, filed on Nov. 10, 2005. The present application is also related to co-pending U.S. patent application Ser. No. 11/377,589 (the “'589 Application”), entitled “Secure Address Proxying Using Multi-key Cryptographically Generated Addresses”, filed on Mar. 16, 2006, and co-pending U.S. patent application Ser. No. 11/377,590 (the “'590 Application”), entitled “Multi-key Cryptographically Generated Address,” filed on Mar. 16, 2006. The '749 Provisional Application, the '589 Application and the '590 Application are hereby incorporated by reference herein in their entireties.

### BACKGROUND OF THE INVENTION

1. Field of the Invention

The present invention relates to route optimization for a moving network. In particular, the present invention relates to provide security in direct communication between a correspondent node and a node in a mobile network, thereby achieving route optimization.

2. Discussion of the Related Art

To optimize routes between nodes in a moving network and nodes outside the mobile network, it is desired that a reliable and authorized proxy network node can be used to inform correspondent nodes about movements of network address owners within the mobile network.

U.S. Patent Application Publication 2002/0133607 entitled “Address Mechanisms in Internet Protocol” (the “Nikander Application”) discloses using a one-way coding function to generate an Internet Protocol (IP) address from components specific to a host. The resulting IP address can then be claimed by the host. In the Nikander Application, a recipient of a message from the host can reconstruct and check the IP address using the components. The claiming host may use an authentication protocol or a public key cryptographic protocol to establish data integrity of the message, and ties the components with the IP address.

U.S. Patent Application Publication 2002/0152384 entitled “Methods and Systems for Unilateral Authentication of Messages” (the “Schelest Application”) discloses deriving an IP Version 6 (IPv6) address by hashing the claiming host's public key. In the Schelest Application, a recipient of a message from the claiming host checks the hash of the IPv6 address, and checks a cryptographic signature in the message to verify its data integrity. If both the IPv6 address and the enclosed signature are verified, the recipient accepts the host's claim of ownership over the IPv6 address.

“Crypto-Based Identifiers (CBIDs): Concepts and Applications” (the “Montenegro Paper”) by Gabriel Montenegro and Claude Castellucia, ACM Transactions on Information and System Security, February, 2004, reviews the use of cryptographically generated identifiers for verifying a host's claim of a right to use an address.

U.S. Patent Application Publication 2003/00849293 entitled “Addressing Mechanisms in Mobile IP” (the “Arkko Application”) discloses an owner node delegating the responsibility for its IP address to a second node at the time the address is generated. In the Arkko Application, the IP address may be cryptographically generated using the methods disclosed in the Nikander or the Schelest Applications. Under the method of the Arkko Application, the owner node obtains the public key portion of a public/private key pair from the second node, and creates an authorization certificate by signing with its own private key over the second node's public key. The authorization certificate is then provided to the second node; the authorization certificate may then be distributed in any message relating to the owner node's IP address. The second node signs such a message—which includes the authorization certificate—with its private key. A recipient of the message uses the second node's public key to authenticate the message and the owner node's public key to authenticate the authorization certificate. The cryptographic hash of the IP address verifies the owner node's right to the IP address and the second node's public key verifies the authorization certificate, thereby establishing the second node's right to send the message on behalf of the owner node.

IETF Request for Comment (RFC) 3972 by Tuomas Aura, March 2005, discloses cryptographically generating an IPv6 address and securing the claim of authorization for the IPv6 address using the neighbor discovery protocol (RFC 2461 and RFC 2462). The IPv6 address is generated using both the cryptographic hash of the public key of the owner node and additional information. 64 bits of cryptographic hash serve as the interface identifier of the IPv6 address.

U.S. Patent Application Publication 2002/0152380 entitled “Methods and Systems for Unilateral Authentication of Messages” (the “O'Shea Application”) discloses using a host's public key (e.g., the method described in the Schelest Application) to cryptographically generate a Mobile IPv6 home address and a care-of address. When the mobile node is outside the home subnet, the Mobile IPv6 home agent in the home network forwards data packets bound for the home address to the care-of address. The mobile node may request that a correspondent node addresses packets directly to the care-of address, rather than through the home address, thus improving routing performance—a process called “binding update for route optimization.” The signaling to optimize routing in this manner requires proof that the mobile node is authorized to claim the new care-of address. The proof may be provided using the cryptographic properties of the network address and a public key signature on the signaling packets. The mobile node signs the binding update signaling packet with the private key corresponding to the public key used to generate the network address. The signaling packet is sent with the source address set to the new, cryptographically generated care-of address. Also included in the signaling packet is the cryptographically generated home address and the mobile node's public key. Upon receiving the signaling packet, the correspondent node checks that the source address and home address can be generated from the included public key, and then checks the signature. If both the source address and the public key are verified, the correspondent node accepts the signaling packet.

RFC 3971 by Jari Arkko, James Kempf, Brian Zill, and Pekka Nikander, March 2005, discloses extending the IPv6 Neighbor Discovery Protocol (described in RFC 2461 and 2462) for secure advertising and defending network addresses, and for secure discovery of last hop IP routers. A node generates a cryptographically generated address according to an algorithm described in RFC 3972, and signs neighbor advertisement packets with an RSA signature. The neighbor advertisement packets claim ownership of the address. This claim is proved by the cryptographic property of the address and the signature on the packet establishes data origin authentication on the packet. Thus, the receiving node can trust that the packet as having come from the claimed source address, and the message establishes the claiming node's authority to claim the network address. The SEND protocol additionally allows for secure discovery of last hop routers. In RFC 3972, a format for a certificate on last hop routers is specified. A router possessing such a certificate signs a router advertisement messages with the private key counterpart of its certified public key. A node seeking a last hop router obtains the router's certificate and a certificate chain leading back to a commonly shared trust root from the router. The node uses the router's certified key to verify the signature on the router advertisement message, thereby obtaining a certified last hop router.

IETF draft “draft-arkko-mipshop-cga-cba-04” (the “Arkko Draft”) by Jari Arkko, Christian Vogt, and Wassim Haddad, June 2006, discloses extending Mobile IPv6 for secure route optimization for a Mobile IPv6 node. In the Arkko Draft, a mobile node sends directly to its correspondent node binding update messages to optimize a propagation route. The correspondent node verifies the claimed address ownership of the mobile node using the mobile node's public key, as disclosed in the RFC 3972. In addition, by reducing the binding update signaling load, it tries to reduce a handoff delay. Redirection based flooding attacks during address ownership verification are prevented by limiting the amount of packet transmission at both nodes.

RFC 3963 by Vijay Devarapalli, Ryuji Wakikawa, Alexandru Petrescu, and Pascal Thubert, January 2005, discloses a protocol for providing a mobile network with connection to the Internet. On behalf of each node inside the mobile network (the “mobile network node”), whether or not the node has mobility functions, a router having Mobile IPv6 functions (the “mobile router”) carries out mobility support functions to provide connection continuity between the mobile network nodes and the Internet. The mobile router establishes a bi-directional tunnel between it and its home agent. Whenever the mobile router changes its point of attachment, it re-establishes the bi-directional tunnel. Under this arrangement, all packets bound for and transmitted from the mobile network nodes are handled by the mobile router's home agent through the bi-directional tunnel.

As can be seen from the above, the Nikander and Schelest Applications, the Montenegro Paper, RFC 3972, O'Shea Application, and RFC 3971 relate only to cases in which authorization to use the network address is claimed by a single host. In addition, the Arkko Draft relates only to route optimization for Mobile IPv6 nodes. However, it may often be necessary to authorize one or more hosts to use an address, whether or not the nodes support mobility functions. An example of such need may be found in mobile network applications and in routing optimization of a mobile network.

As can be seen from the above, RFC 3963 provides that all packets are to be propagated through a bi-directional tunnel between a mobile router and its home agent. This sub-optimal routing scheme is not necessary if a reliable and authorized proxy mobile router exists, which can send binding update messages directly to correspondent nodes on behalf of mobile network nodes. The correspondent nodes may then verify that the binding update messages including the newly acquired address are sent from an authorized node. However, if a mobile network node is to generate the address using a cryptographic identifier tied to its public key alone, only it can send a secure binding update message. The proxy binding update message by the mobile router must be done without security.

While the Arkko Application discloses an owner node delegating advertising and defense of its address to another party, the solution in the Arkko Application is cumbersome. In the Arkko Application, in addition to using both the owner node's and the delegated node's public keys, an attribute certificate is also required. After generating the address, the attribute certificate is sent by the owner node to the delegated node. As described in the Arkko Application, the solution in the Arkko Application identifies whether the claimant is the owner node or the delegated node. This information can be used by an attacker to infer the location or other information about the owner host.

### SUMMARY

According to one aspect of the present invention, a method allows a router to perform proxy secure route optimization inside a mobile network. In one embodiment, a mobile node in a mobile network receives from a mobile router a router advertisement message containing a mobile network prefix and a public key of the mobile router. The mobile node generates a multi-key cryptographically generated address (MCGA) using the mobile network prefix, and both its own public key and the mobile router's public key. This MCGA is then made known to the mobile router. In one embodiment, the mobile router caches the MCGA and the mobile node's public key. Then, the mobile router is authorized to perform secure proxy route optimization.

The present invention also provides a method which allows a mobile router to send binding update messages to correspondent nodes on behalf of the mobile nodes, so as to enable route optimization. In one embodiment, instead of the mobile network node, a mobile router sends a secured binding update message to a correspondent node of the mobile network node. In that instance, the mobile network nodes are relieved of performing mobility functions when a change of location or a change of a care-of address occurs.

According to another aspect of the present invention, a secure protocol allows a correspondent node to verify the authority of a mobile node claiming an address. The correspondent node checks the mobile node's network address and a signature on the message using the public keys that are used to generate the network address. In addition, the mobile node claiming the address includes in its request a signature signed using a private key corresponding to the public key or keys used to create the network address. The signature may be a ring signature formed using all the public keys that form the network address.

According to one aspect of the present invention, a network address may be auto-configured by a mobile network node. The mobile network node creates the network address using a mobile router's public key and a network prefix using a suitable protocol. Examples of suitable protocols include the SEND protocol, or an extension to IPv6 router discovery of mobile node keys. The router may obtain the mobile node's public key by having the mobile node include its public key in standard SEND neighbor discovery messages.

The present invention also provides a method for a mobile node to securely claim and defend a network address. In one embodiment, the method includes receiving an address resolution request for a network address, which is formed from at least the mobile network node's public key and a mobile router's public key. The method responds to the address resolution request by sending a message to the sender, enclosing the public keys. The sender of the address resolution request checks the network address using the public keys received, and verifies a signature on the message, which is signed using a private key by the mobile network node or the mobile router.

Thus, the present invention allows mobile routers to send binding update directly to the correspondent nodes on behalf of IPv6 mobile network nodes for route optimization and allows the correspondent nodes to verify the authorization of the mobile router.

The present invention is better understood upon consideration of the present invention and the accompanying drawings.

### BRIEF DESCRIPTION OF THE DRAWINGS

FIG. 1 illustrates an IPv6 mobile network node A configuring an MCGA using its own public key and mobile router B's public key.

FIG. 2 shows mobile router B sending a binding update message to its own home agent.

FIG. 3 illustrates establishing a packet routing between a mobile network node and its correspondent node under IPv6 basic support (i.e., without route optimization).

FIG. 4 shows a secure binding update protocol in which mobile router B sends a binding update message on behalf of a mobile network node for the first time to a correspondent node of the mobile network node, to allow route optimization, so that subsequent data packets may be sent over an optimized route.

FIG. 5 illustrates a much simpler binding update protocol for subsequent changes in network attachment subsequent to the initial binding update protocol of FIG. 4.

FIG. 6 compares the routing optimizations that can take place without a secure route optimization and with a secure route optimization.

### DETAILED DESCRIPTION OF THE PREFERRED EMBODIMENTS

The present invention allows mobile routers that use mobile IPv6 for mobility management to securely optimize routing by sending binding update messages directly to the correspondent nodes on behalf of IPv6 mobile network nodes. For example, according to one embodiment, an IPv6 mobile network node generates a multi-key cryptographically generated IPv6 address (MCGA) using a combination of a network prefix, a public key advertised from a mobile router and its own public key. Both the mobile network node and the mobile router may sign and verify a message that claims a network address. When a mobile network changes its point of attachment, the mobile router sends a secure binding update message directly to the correspondent node on behalf of the mobile network node. With this MCGA provided to the correspondent node in a secure manner, subsequent data packets can be sent over an optimized route.

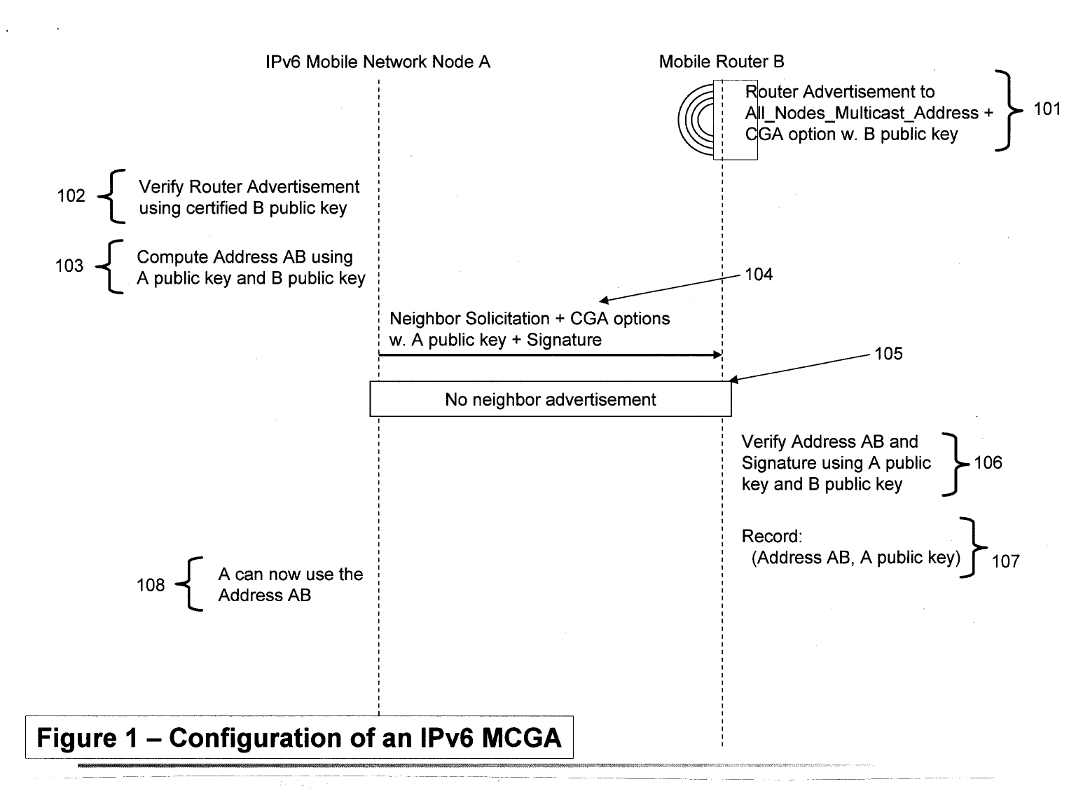

FIG. 1 shows IPv6 MCGA configuration at an IPv6 mobile network node (say, “mobile network node A”). As shown in FIG. 1, at step 101, a mobile router (say, “mobile router B”) multicasts a router advertisement message to an IPv6 multicast address (i.e., an “All_Nodes_Multicast_Address”) according to the requirements of RFC 2462. The router advertisement message contains a mobile network prefix and a public key (i.e., mobile router B's own public key) in a CGA option according to, for example, the requirements of RFC 3971. Then, at step 102, mobile network node A verifies mobile router B's address using mobile router B's public key. If successfully verified, at step 103, mobile network node A generates an MCGA (“address AB”) using the mobile network prefix, and both mobile router B's public key and mobile network node A's own public key. At step 104, mobile network node A executes a duplicate address detection protocol by sending a neighbor solicitation to address AB, providing mobile network node A's public key in a CGA option. Mobile network node A may also include a signature in the neighbor solicitation using its public key, mobile router B's public key, and mobile network node A's private key (which complements mobile network node A's public key). When no response to the neighbor solicitation is received after a predetermined time period (at step 105), at step 106, mobile router B verifies address AB and the signature in the neighbor solicitation using mobile network node A's public key and mobile router B's own public key. At step 107, mobile router B records the binding between address AB and mobile network node A's public key for future reference. At the same time (step 108), since address AB is now deemed not a duplicate address, mobile network node A can use address AB as a source address for its IP traffic. To prevent an attacker from spoofing address AB, mobile network node A and mobile router B may deploy, for example, the certification path solicitation/advertisement technique described in RFC 3971.

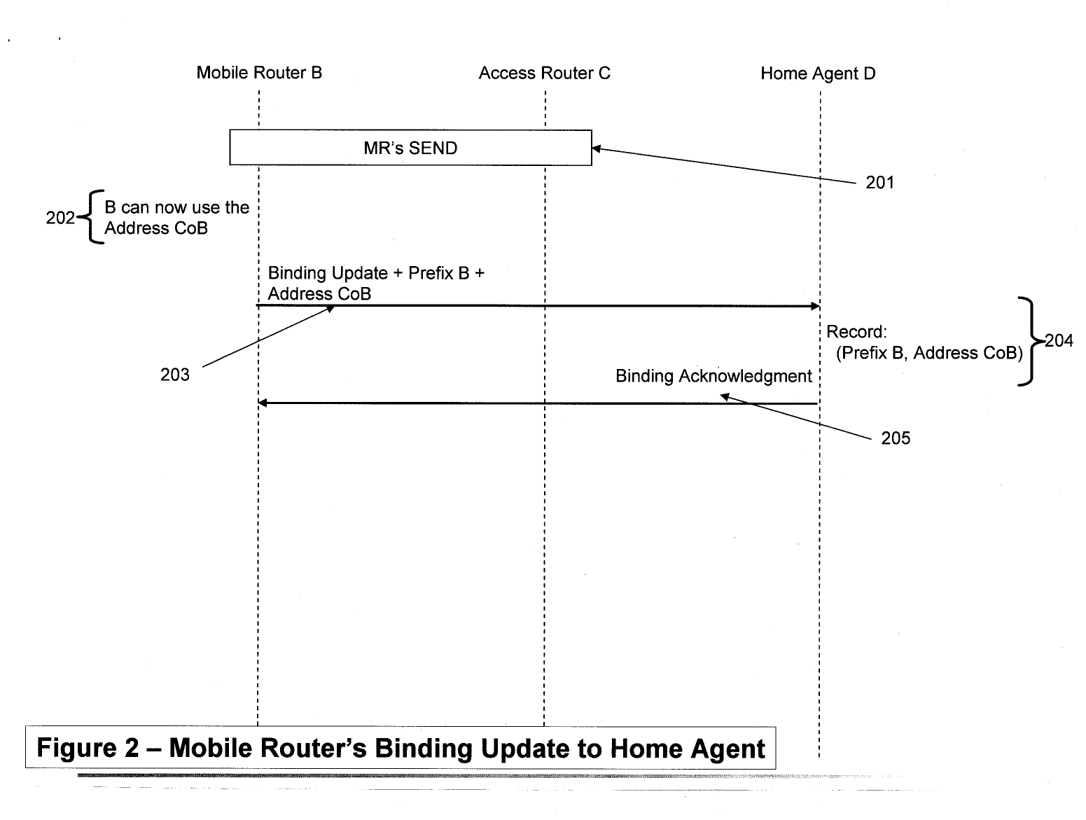

FIG. 2 illustrates mobile router B sending a binding update message to its home agent when the mobile network's point of attachment changes. In this embodiment, mobile router B uses Mobile IPv6 functions for mobility management. Accordingly, mobile router B sends a binding update message to its own home agent (“home agent D”) to ensure connectivity to the Internet, when mobile router B changes the point of attachment. (FIG. 2 shows a new point of attachment at “access router C.”) Under this arrangement, the mobile network nodes (e.g., mobile network node A) in mobile router B's mobile network need not send their own binding update messages to their respective home agents. In accordance with RFC 3971, at step 201, mobile router B and access router C execute the SEND protocol to generate mobile router B's new address (“care-of address B” or “address CoB”). At step 202, mobile router B uses address CoB in subsequent data packets. At step 203, mobile router B sends a binding update message to home agent D, using mobile router B's mobile network prefix (“mobile network prefix B”) and address CoB. The binding update message may also include the router flag described in RFC 3963. At step 204, home agent D records mobile network prefix B and address CoB in a table for future reference. Then, at step 205, home agent 205 sends a binding acknowledgment message to mobile router B.

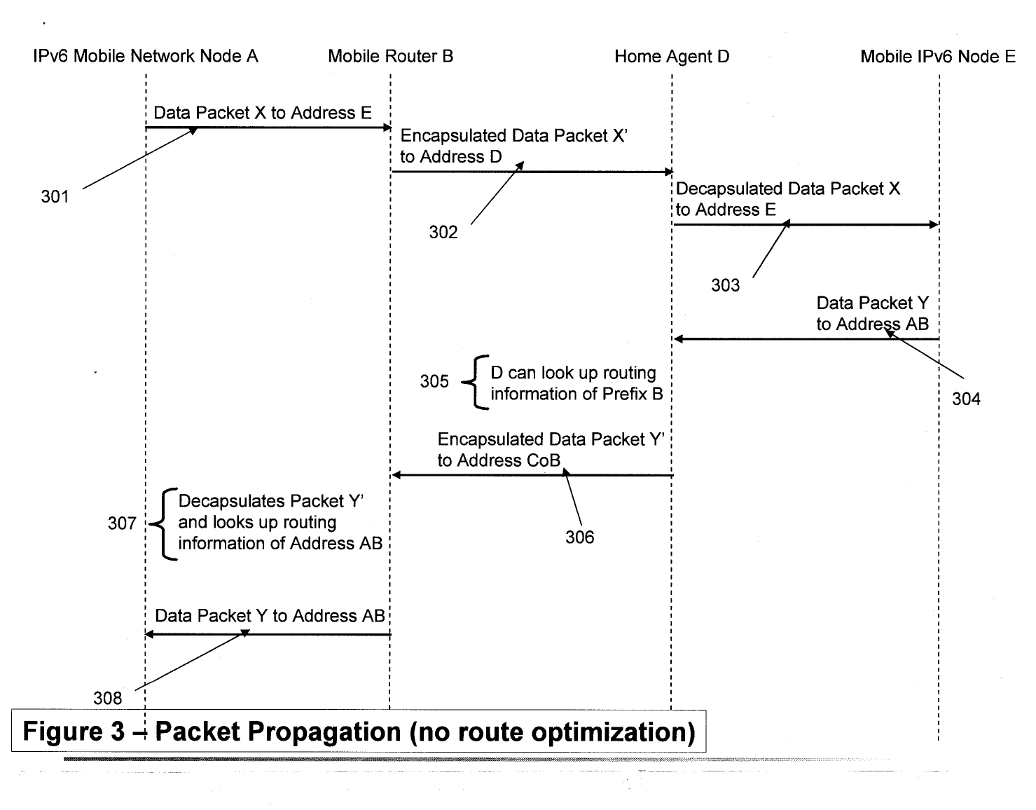

FIG. 3 illustrates establishing a packet routing between a mobile network node and its correspondent network node, using IPv6 basic support (i.e., no route optimization). Under IPv6 basic support, as described in RFC 3963, all data packets are propagated through a bidirectional tunnel between mobile router B) and its home agent D. At step 301, mobile network node A sends a data packet (“packet X”) to the correspondent node (“network node E”). At step 302, mobile router B encapsulates packet X in an IPv6 packet destined to home agent D. At step 303, upon receiving packet X, home agent D de-capsulates and forwards packet X to its intended destination, using the address of network node E. To send a data packet (“packet Y”) from network node E to mobile network node A, network node E using address AB as the destination address. When home agent D receives packet Y at step 304, home agent D uses mobile network prefix B to look up address CoB from the table where it previously recorded the mobile network prefix B and address CoB (step 305). Then, at step 306, home agent D encapsulates packet Y into an IPv6 data packet (“packet Y′”) and sends packet Y′ to mobile router B, specifying address CoB as the destination address. Upon receiving packet Y′, mobile router B decapsulates packet Y′ to recover packet Y, while looking up a routing table for address AB (step 307). At step 308, mobile router sends packet Y to mobile network node A. Note that if all packets are forwarded through the bidirectional tunnel between mobile router B and home agent D, packets therefore may not be propagating over an optimized route. To support route optimization in a secure way, in a method of the present invention, mobile router B can send a binding update message to network node E on behalf of mobile network node A, even if mobile network node A is not capable of mobile IPv6 functions.

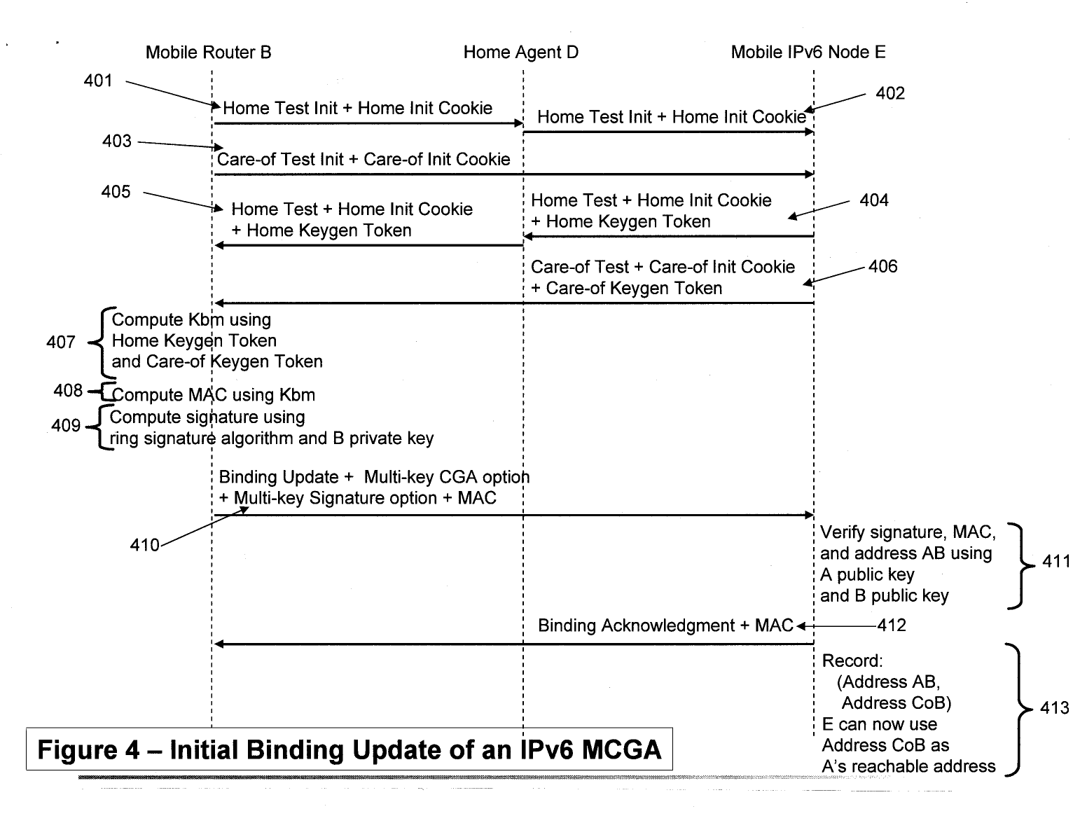

FIG. 4 shows an initial secure binding update protocol in which a binding update message is sent from mobile router B to network node E on behalf of a mobile network node (e.g., mobile network node A). Before mobile router B can send a secure binding update message to network node E, mobile router B and network node E execute a return routability protocol to ensure reachability (step 401 to 406) according, for example, to RFC 3775. At step 401 and 402, mobile router B sends a home test init request, enclosing a home init cookie, to network node E by way of home agent D. The home test init request specifies address AB as the source address. At the same time, mobile router B sends a care-of test init request, enclosing a care-of test cookie, to network node E directly, specifying address CoB as the source address (step 403). At steps 404 and 405, network node E computes a home keygen (i.e., key generation) token based on the home init cookie, and sends the home keygen token, along with the home init cookie, in a home test response to mobile router B by way of home agent D. At step 406, network node E computes a care-of keygen token, based on the care-of init cookie and sends the care-of keygen token, along with the care-of init cookie, in a care-of test response to mobile router B directly. Then, at step 407, mobile router B constructs a kbm (key for binding management) from the home keygen token and the care-of keygen token. The kbm is used as a security association key for a “semi-permanent” time period. At step 408, using the kbm, mobile router B computes the message authentication codes (MAC) for the binding update message in accordance with RFC 3775. In addition, at step 409, mobile router B calculates a signature for the binding update message using mobile router B's private key. This signature may be, for example, a ring signature. At step 410, mobile router B includes the signature in the signature option of the binding update message sent to network node E. In addition, the binding update message includes (a) the MAC in a binding authorization data option, (b) address CoB in a source address field, and (c) mobile network node A's and mobile router B's public keys in a multi-key CGA option. At step 411, network node E verifies the signature, the MAC, and the MCGA of mobile network node A (i.e., address AB) using mobile network node A's public key and mobile router B's public key. At step 412, when address AB is successfully checked and the signature is successfully verified, network node E sends back a binding acknowledgment message to mobile router B, specifying as source address network node E's address and address CoB as the destination address. The binding acknowledgement message may also include (a) the MAC computed on the binding acknowledgement message in a binding authorization data option, and (b) address AB in, for example, in a home address option, so that mobile router B can change the destination address in subsequent data packets from address CoB to address AB. At step 413, network node E records address AB and address CoB in a table for future reference. From this point, network node E can use address CoB as the reachable address to mobile network node A.

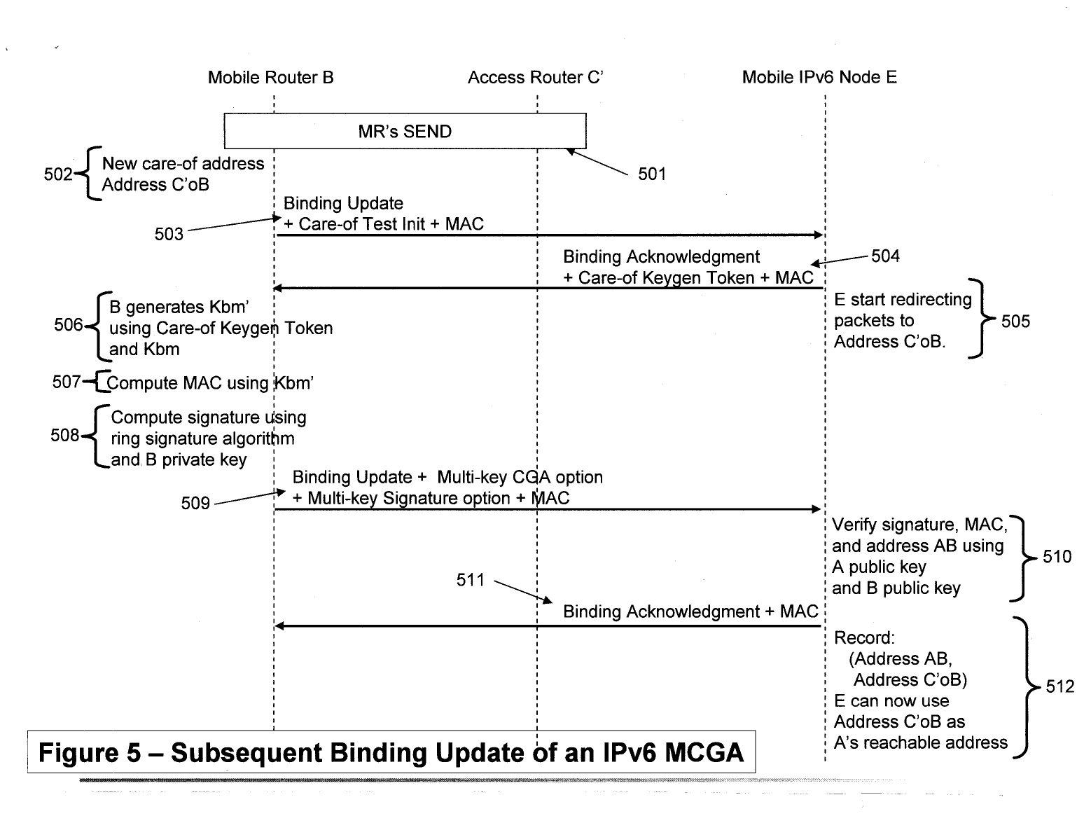

As the Arkko Draft points out, signaling load results in long delay when a Mobile IPv6 node moves. FIG. 5 illustrates a much simpler binding update protocol for subsequent changes in network attachment subsequent to the initial binding update protocol of FIG. 4. If the point of attachment for mobile router B changes to a new access router (i.e., access router C), mobile router B and access router C execute a SEND protocol, as shown in step 501. Then, at step 502, mobile router B establishes its new care-of address (“address CoB′”). At step 503, mobile router B sends to network node E a tentative binding update message (also, the care-of test request), which includes new address CoB′ as the source address. Mobile router B also includes in the message the MAC computed on the tentative binding update message in the binding authorization data option, using the previously obtained kbm. At step 504, network node E also computes the MAC on a tentative binding acknowledgement message, and returns to mobile router B the tentative binding acknowledgment message with a new care-of keygen token, generated using address CoB′. At step 505, network node E redirects all payload packets destined to address AB to address CoB′. During these steps, mobile network node A and network node E may send payload packets through mobile router B. Those packets are allowed as far as enough credits are left in accordance with the Arkko Draft. At step 506, using the newly received care-of keygen token and the kbm, mobile router B generates a new binding management key kbm′ to be used in an actual binding update message that is next sent. At step 507, mobile router B computes the MAC on the actual binding update message using kbm′. At step 508, mobile router B calculates a signature on the actual binding update message using B's private key. The signature again may be a ring signature. At step 509, mobile router B sends the actual binding update message along with (a) mobile network node A's and mobile router B's public keys in the multi-key CGA option, (b) the signature in the signature option, and (c) the MAC in the binding authorization data option. After verifying the signature, the MAC, and address AB at step 510, network node E sends to mobile router B a binding acknowledgment message that includes a newly calculated MAC computed at step 511. At step 512, network node E records address AB and address CoB′. For subsequent data packets, network node E uses address CoB′ as the reachable address for mobile network node A.

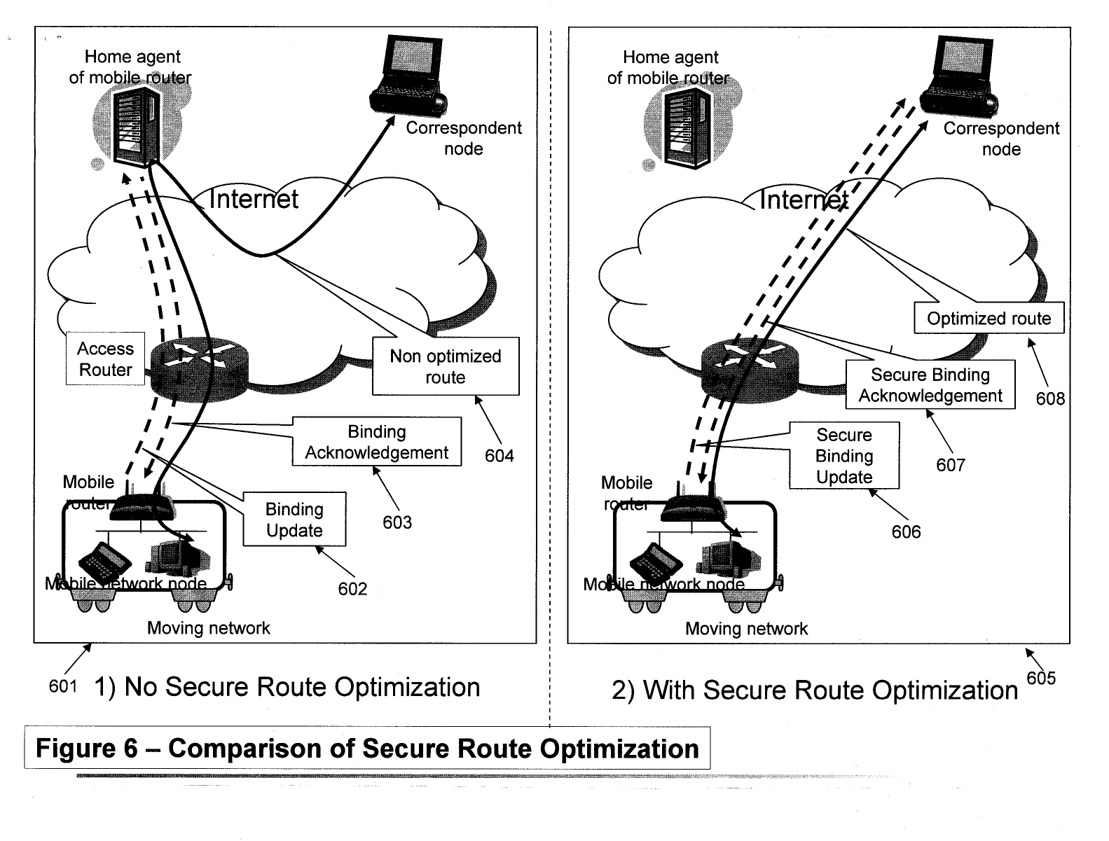

FIG. 6 illustrates compares packet routes from the route optimization's point of view. Case 601 shows the case when no secure route optimization is used. At step 602, mobile router B sends a binding update message to its home agent D to notify of its new address. After home agent D sends back a binding acknowledgment message to mobile router B (step 603), all packets between the mobile network nodes (e.g., mobile network node A) and their correspondent nodes (e.g., network node E) are propagated over non-optimized route 604 by way of home agent D. In contrast, case 602 allows a secure route optimization to be used. In case 602, mobile router B sends a secure binding update message directly to network node E (step 606) for route optimization, with appropriate parameters. These parameters include (a) public keys in a multi-key CGA option, and (b) a ring signature in a signature option. Then, network node E sends back to mobile router B a secure binding acknowledgment message 607, including appropriate security parameters. Thereafter, all data packets between mobile network node A and network node E can be sent over an optimized route, labeled by reference numeral 608. Since mobile router B is authorized to use mobile network node A's address (i.e., address AB), mobile router B can be proxy to send a binding update message to network node E on behalf of mobile network node A. Since network node E can verify and authenticate the binding update message from mobile router B, a reliable optimized route can be used without tunneling through home agent D.

The above detailed description is provided to illustrate specific embodiments of the present invention and is not intended to be limiting. Numerous modifications and variations within the scope of the present invention are possible. The present invention is set forth in the accompanying drawings.

I claim:

1. A method for allowing a mobile router to perform secure proxy binding update for a mobile network node, comprising:
receiving a network prefix and a public key associated with the mobile router; and
creating a network address using the network prefix, a public key associated with the mobile network node, and the public key from the mobile router.

2. A method as in claim 1, wherein the mobile network node creates the network address.

3. A method as in claim 1, wherein the mobile router checks the network address using the public key of the mobile network node and the public key associated with the mobile router.

4. A method as in claim 1, further comprises sending, from the mobile router, a binding update message to a correspondent node of the mobile network node when a change in point of attachment occurs.

5. A method as in claim 4, wherein the binding update message contains a new care-of address for the mobile router.

6. A method as in claim 4, wherein the mobile router includes in the binding update message both the public key associated with the mobile network node and the public key associated with the mobile router.

7. A method as in claim 1, wherein the mobile network node obtains the public key associated with the mobile router using a address resolution protocol.

8. A method as in claim 7, wherein the address resolution protocol comprises the SEND protocol.

9. A method as in claim 4, wherein the correspondent node checks the network address using the public key associated with the mobile network node and the public key associated with the mobile router.

10. A method as in claim 4, further comprising in the binding update message a signature signed by the mobile router using a private key.

11. A method as in claim 9, wherein the signature comprises a ring signature.

12. A method as in claim 9, wherein the correspondent node checks the signature in the binding update using the public keys of the mobile network node and of mobile router.
